(19) United States
(12) Patent Application Publication
(10) Pub. No.: US 2026/0339441 A1
(43) Pub. Date: Oct. 29, 2026

(54) METHOD AND DEVICE FOR PRODUCING VIRTUAL REALITY 3D CURVE NETWORK USING BIMANUAL INTERACTION

(71) Applicant: Korea Advanced Institute of Science and Technology, Daejeon (KR)

(72) Inventors: Seok-Hyung Bae, Daejeon (KR); Sanghyun Lee, Daejeon (KR); Taegyu Jin, Daejeon (KR); Joon Hyub Lee, Daejeon (KR)

(73) Assignee: Korea Advanced Institute of Science and Technology, Daejeon (KR)

(21) Appl. No.: 19/122,372

(22) PCT Filed: Oct. 20, 2023
(86) PCT No.: PCT/KR2023/016349

§ 371 Date: Apr. 18, 2025

(30) Foreign Application Priority Data
Oct. 20, 2022 (KR) 10 2022 0135312
Oct. 18, 2023 (KR) 10-2023-0139638

(51) Int. Cl. G06F 3/01; G06T 19/20; G06V 40/20

(52) U.S. Cl. CPC G06F 3/017; G06T 19/20; G06T 2219/2021; G06V 40/28

(57) ABSTRACT

The present invention relates to a method and device for producing a virtual reality 3D curve network using bimanual interaction, wherein a gesture made by at least one hand of a user is detected in space and a 3D curve network composed of a plurality of lines each defined by two vertexes is produced. The gesture may be based on a pinch gesture made by two fingers and a grab gesture made by five fingers

### TECHNICAL FIELD

The present disclosure relates to a method and device for producing a virtual reality three-dimensional (3D) curve network using bimanual interaction.

### RELATED ART

Virtual reality (VR) allows a user to view objects in their real sizes, which is useful to produce three-dimensional (3D) content. In such an immersive environment, a method of freely drawing 3D lines in the air is widely used due to its excellent expressiveness. However, this method has low precision, making it difficult to draw sophisticated curves.

### DETAILED DESCRIPTION

### Technical Subject

The present disclosure proposes a novel method of generating three-dimensional (3D) curves in virtual reality with high expressiveness and precision.

The present disclosure provides a method and device for intuitively producing a 3D curve network using bimanual interaction in virtual reality.

### Solution

According to the present disclosure, a method of producing a virtual reality three-dimensional (3D) curve network using bimanual interaction of an electronic device may include detecting a gesture of at least one hand of a user in space; and producing a 3D curve network that includes a plurality of lines according to the gesture in the space and in which each of the lines is defined between two vertices, and the gesture may be based on a pinch gesture by two fingers and a grab gesture by five fingers.

According to the present disclosure, an electronic device for producing a virtual reality 3D curve network using bimanual interaction may include a camera module; a display module; and a processor configured to detect a gesture of at least one hand of a user in space through the camera module, and to produce a 3D curve network that includes a plurality of lines according to the gesture in the space and in which each of the lines is defined between two vertices through the display module, and the gesture may be based on a pinch gesture by two fingers and a grab gesture by five fingers.

### Effect

According to the present disclosure, a user may intuitively produce a three-dimensional (3D) curve network using bimanual interaction in virtual reality through an electronic device. In detail, the electronic device allows the user to easily generate and modify lines at real-world scales in virtual reality through a gesture of both hands while directly viewing the lines. Therefore, in virtual reality, the 3D curve network may be generated with high expressiveness and precision.

### BRIEF DESCRIPTION OF DRAWINGS

FIG. 1 is a block diagram illustrating an electronic device according to various example embodiments.

FIG. 2 is an example view for explaining operation characteristics of an electronic device according to various example embodiments.

FIGS. 3 and 4 are conceptual views for explaining gestures used in an electronic device according to various example embodiments.

FIGS. 5, 6, 7, 8, 9, 10, 11, 12, 13, 14, 15, and 16 are example views for explaining bimanual interaction based on gestures of FIGS. 3 and 4 of an electronic device according to various example embodiments.

FIG. 17 is a flowchart illustrating an operating method of an electronic device according to various example embodiments.

### BEST MODE

Hereinafter, various example embodiments of the present disclosure are described with reference to the accompanying drawings.

In the following, a dominant hand (DH) may refer to a hand that a user primarily uses between both hands, and a non-dominant hand (NDH) may refer to a hand that the user does not primarily use between both hands. For example, if the user is right-handed, the dominant hand may be the right hand and the non-dominant hand may be the left hand. Meanwhile, if the user is left-handed, the dominant hand may be the left hand the non-dominant hand may be the right hand.

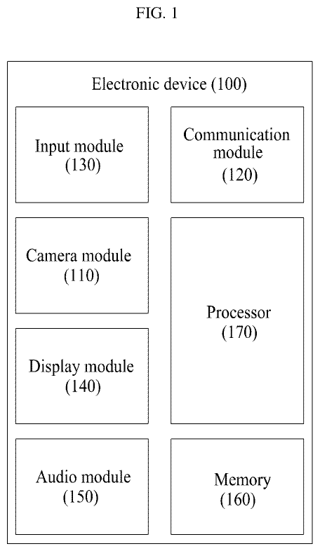

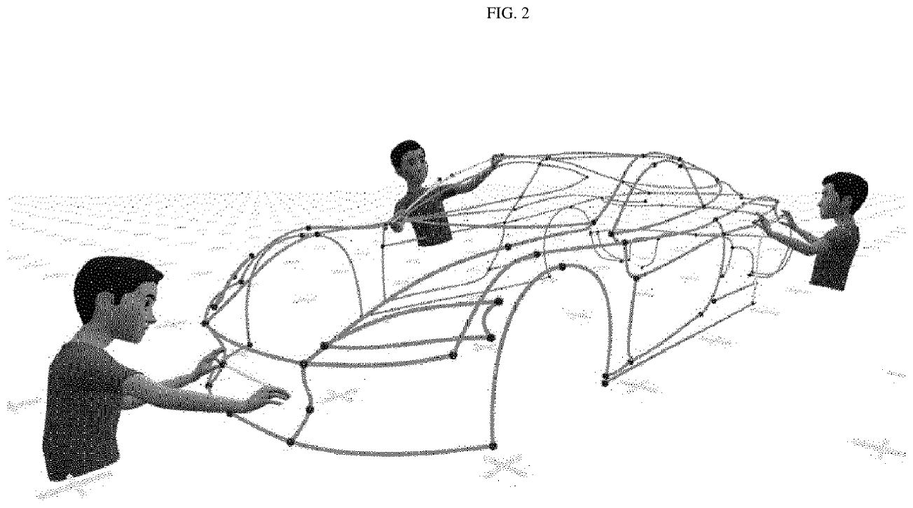

FIG. 1 is a block diagram illustrating an electronic device 100 according to various example embodiments. FIG. 2 is an example view of explaining operation characteristics of the electronic device 100 according to various example embodiments.

Referring to FIG. 1, the electronic device 100 to produce a three-dimensional (3D) curve network using bimanual interaction may be provided. Here, the electronic device 100 may be implemented as a near-eye display (NED) device that may be worn on the user's face or head. For example, the near-eye display device may include at least one of smart glasses and a head mount display (HMD) device.

The electronic device 100 may include at least one of a camera module 110, a communication module 120, an input module 130, a display module 140, an audio module 150, a memory 160, and a processor 170. In some example embodiments, at least one of the components of the electronic device 100 may be omitted, and at least one another component may be added to the electronic device 100. In some example embodiments, at least two of the components of the electronic device 100 may be implemented as a single integrated circuit.

The camera module 110 may capture a video. Here, when the electronic device 100 is implemented as a near-eye display device, the camera module 110 may capture a video of a front view of the user wearing the electronic device 100. For example, the camera module 110 may include at least one lens, at least one image sensor, at least one image signal processor, and at least one flash.

The communication module 120 may communicate with an external device (not shown) in the electronic device 100. The communication module 120 may establish a communication channel between the electronic device 100 and the external device and may perform communication with the external device through the communication channel. The communication module 120 may include at least one of a wired communication module and a wireless communication module. For example, the wireless communication module may communicate with the external device through at least one of a far field communication network or a near field communication network.

The input module 130 may input a signal to be used for at least one component of the electronic device 100. The input module 130 may be configured to detect a signal directly input from the user or to generate a signal by detecting a change in surroundings. For example, the input module 130 may include at least one of a microphone, at least one physical button, and a touch pad. The touch pad may be configured to detect a contact, that is, touch by the user's hand and to generate a touch signal in response thereto. Here, the touch pad may include at least one of a touch circuitry configured to detect a touch and a sensor circuitry configured to measure intensity of force generated by the touch.

The display module 140 may visually output information to the outside of the electronic device 100. In detail, the display module 140 may be configured to display visual content. Here, when the electronic device 100 is implemented as a near-eye display device, the display module 140 may be provided in front of eyes of the user wearing the electronic device 100. The display module 140 may be displayed in a different manner depending on a type of the electronic device 100. For example, when the electronic device 100 is an optical see-through type, at least a portion of the display module 140 may be made of a transparent or translucent material, and the user may directly view a real environment through the display module 140. In this case, as the display module 140 displays visual content, the user may view the real environment and the visual content together. As another example, when the electronic device 100 is a video see-through type, the user may view a video of the real world that is captured by the camera module 110 through the display module 140. In this case, as the display module 140 displays the visual content, the user may view the video of the real world and the visual content together.

The audio module 150 may auditorily output information to the outside of the electronic device 100. For example, the audio module 150 may include at least one of a speaker and a receiver.

The memory 160 may store a variety of data used by at least one component of the electronic device 100. For example, the memory 160 may include at least one of a volatile memory and a non-volatile memory. Data may include at least one program and input data or output data related thereto. The program may be stored in the memory 160 as software including at least one instruction and may include at least one of an operating system (OS), middleware, and an application.

The processor 170 may control at least one component of the electronic device 100 by executing the program of the memory 160. Through this, the processor 170 may perform data processing or operation. Here, the processor 170 may execute an instruction stored in the memory 160.

According to various example embodiments, the electronic device 100 may produce a virtual reality three-dimensional (3D) curve network using bimanual interaction of the user. In detail, while the user is wearing the electronic device 100, the electronic device 100 may produce a virtual 3D curve network according to a gesture of at least one hand of the user in space. Here, the 3D curve network may include a plurality of lines, and each line may be defined between two vertices. Here, each line may be a straight line or a curved line. For example, as shown in FIG. 2, the electronic device 100 may produce the 3D curve network for automobile design.

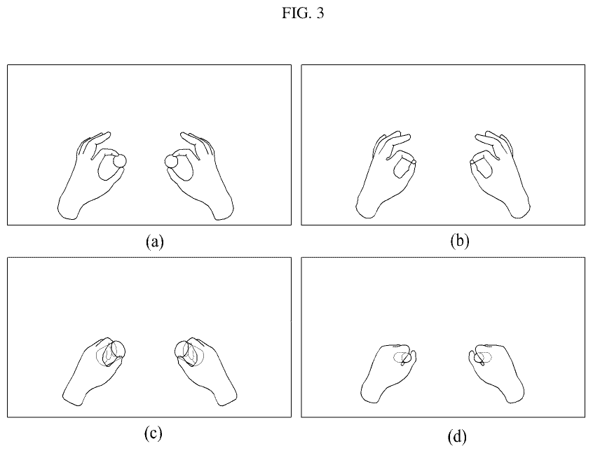

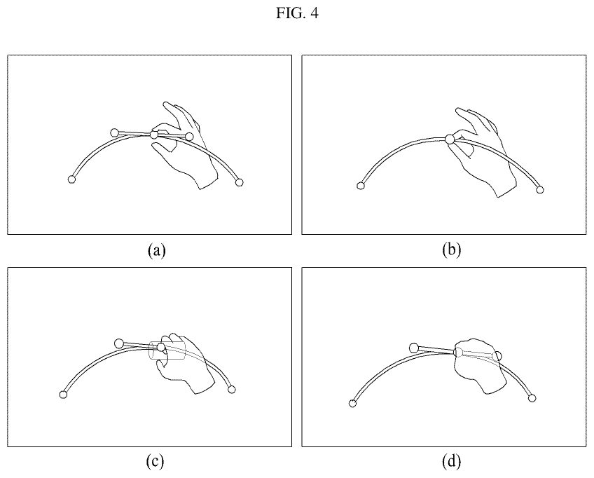

FIGS. 3 and 4 are conceptual views for explaining gestures used in the electronic device 100 according to various example embodiments.

Referring to FIG. 3, a gesture may be based on a pinch gesture and a grab gesture. The pinch gesture may be formed by two fingers of one hand, and the grab gesture may be formed by five fingers of one hand. Based on this, the gesture may include a loose-pinch gesture, a tight-pinch gesture, a loose-grab gesture, and a tight-grab gesture.

In detail, as shown in (a) of FIG. 3, in the loose-pinch gesture, two fingers may be spaced apart from each other, and as shown in (b) of FIG. 3, in the tight-pinch gesture, two fingers may be in close contact with each other. The user may perform the loose-pinch gesture as if the user is holding a small virtual ball between two fingers in the space, and may perform the tight-pinch gesture as if the user is holding a much smaller virtual ball between two fingers in the space. As shown in (a) of FIG. 4, when the user performs the loose-pinch gesture at a single vertex, the electronic device 100 may display a cursor and at least one control point adjacent to the cursor, to correspond to the vertex. Here, the cursor may impose constraints on a position of the vertex. Here, the cursor may be in a spherical shape. Meanwhile, as shown in (b) of FIG. 4, when the user performs the tight-pinch gesture at a single vertex, the electronic device 100 may allow the position of the vertex to be modifiable.

Meanwhile, as shown in (c) of FIG. 3, in the loose-grab gesture, at least some of the five fingers may be spaced apart from each other, and as shown in (d) of FIG. 3, in the tight-grab gesture, the five fingers may be in close contact with each other. Here, the user may perform the loose-grab gesture as if the user is holding a small cylinder between the five fingers, that is, within the palm in the space, and may also perform the tight-grab gesture as if the user is holding a much smaller cylinder within the palm in the space. As shown in (c) of FIG. 4, when the user performs the loose-grab gesture at a single vertex, the electronic device 100 may display a cursor and at least one control point adjacent to the cursor, to correspond to the vertex. Here, the cursor may impose constraints on a position and the tangent of the vertex. Here, the vertex may be in a cylindrical shape. Meanwhile, as shown in (d) of FIG. 4, when the user performs the tight-grab gesture at a single vertex, the electronic device 100 may allow a position and the tangent of the vertex to be modifiable.

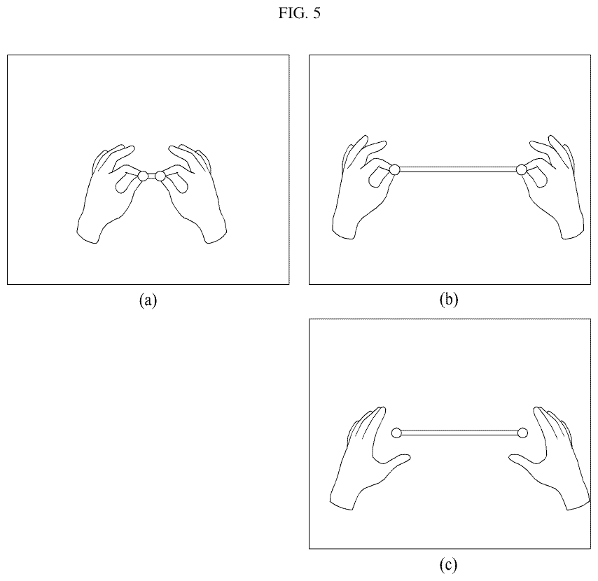

FIGS. 5, 6, 7, 8, 9, 10, 11, 12, 13, 14, 15, and 16 are example views for explaining bimanual interaction based on gestures of FIGS. 3 and 4 of the electronic device 100 according to various example embodiments.

Referring to FIG. 5, the electronic device 100 may generate a straight line in space. In detail, as shown in (a) of FIG. 5, the electronic device 100 may detect the tight-pinch gesture for each of the user's both hands. In this case, the electronic device 100 may generate vertices at positions of both hands and may generate a straight line that connects the vertices. In some example embodiments, only when a distance between both hands is less than or equal to a predetermined distance, the electronic device 100 may generate the straight line, and when the distance between both hands is greater than the predetermined distance, the electronic device 100 may ignore the tight-pinch gesture. Additionally, as shown in (b) of FIG. 5, if the distance between both hands increases, the electronic device 100 may extend the straight line while moving vertices to positions of the both hands. Here, as shown (c) of FIG. 5, if the tight-pinch gesture is released, the electronic device 100 may maintain the straight line in the space.

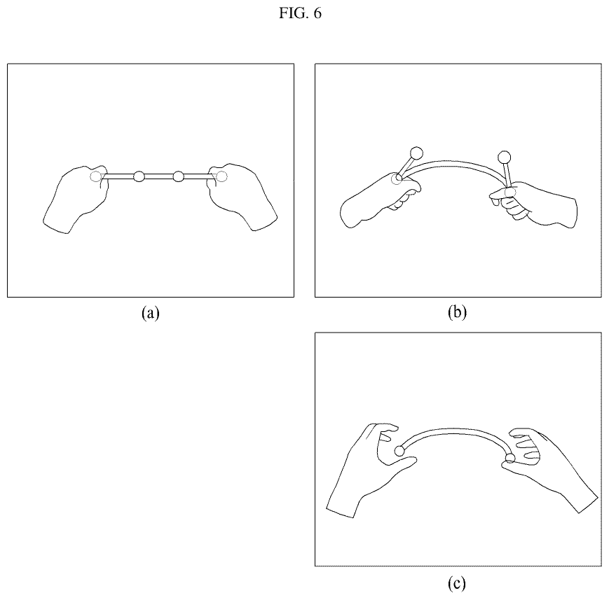

Referring to FIG. 6, the electronic device 100 may generate a curve in the space. In detail, as shown in (a) of FIG. 6, the electronic device 100 may detect the tight-grab gesture at each of vertices in the straight line for both hands of the user. In this case, as shown in (b) of FIG. 6, as directions of both hands change, the electronic device 100 may generate a curve by bending the straight line. Here, as shown in (c) of FIG. 6, if the tight-grab gesture is released, the electronic device 100 may maintain the curve in the space.

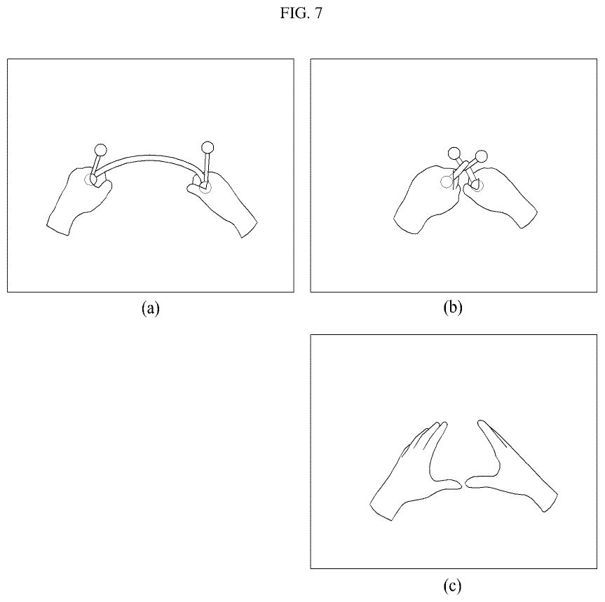

Referring to FIG. 7, the electronic device 100 may remove a line in space. In detail, as shown in (a) of FIG. 7, the electronic device 100 may detect the tight-grab gesture at each of vertices in a line for both hands of the user. In this case, as shown in (b) of FIG. 7, a distance between both hands decreases to be less than or equal to a predetermined distance. As shown in (c) of FIG. 7, if the tight-grab gesture is released, the electronic device 100 may remove the line in the space. Although FIG. 7 illustrates an example of removing a curve, a straight line may also be removed in a similar manner.

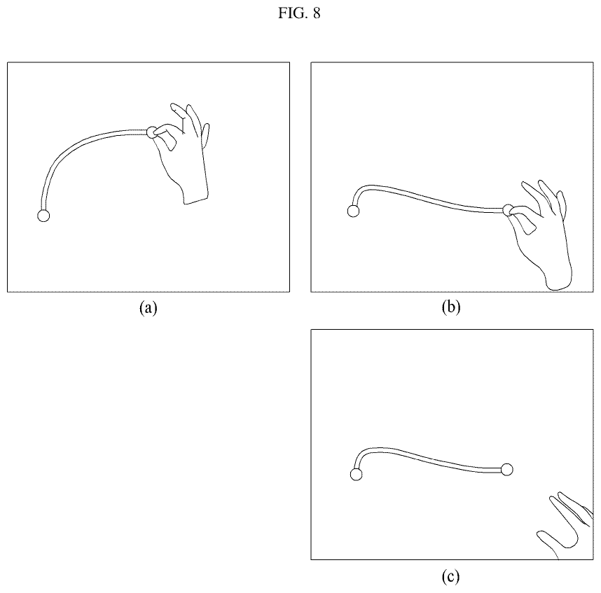

Referring to FIG. 8, the electronic device 100 may edit a line in space. In detail, as shown in (a) of FIG. 8, the electronic device 100 may detect the tight-pinch gesture at a single vertex in a line for one hand of the user. In this case, as shown in (b) of FIG. 8, as the hand moves, the electronic device 100 may move the vertex. Here, the electronic device 100 may change the line while maintaining the tangent at the vertex. That is, since the line is connected to another vertex, the line may change as the vertex moves. Here, as shown in (c) of FIG. 8, if the tight-pinch gesture is released, the electronic device 100 may maintain the line. Although FIG. 8 illustrates an example of changing a curve, a straight line may also be changed in a similar manner.

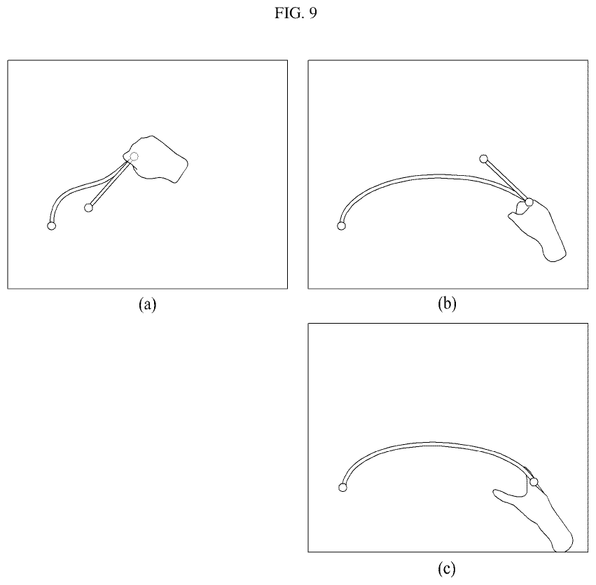

Referring to FIG. 9, the electronic device 100 may edit a line in space. In detail, as shown in (a) of FIG. 9, the electronic device 100 may detect the tight-grab gesture at a single vertex in a line for one hand of the user. In this case, as shown in (b) of FIG. 9, as the hand moves, the electronic device 100 may move the vertex. Here, the electronic device 100 may change the line along with the tangent at the vertex. That is, since the line is connected to another vertex, the line may change as the vertex moves. Here, as shown in (c) of FIG. 9, if the tight-grab gesture is released, the electronic device 100 may maintain the line. Although FIG. 9 illustrates an example of changing a curve, a straight line may also be changed in a similar manner.

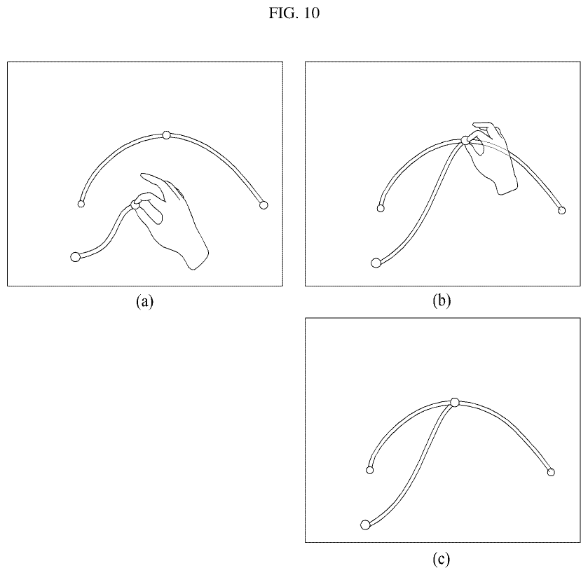

Referring to FIG. 10, the electronic device 100 may connect lines in space. In detail, as shown in (a) of FIG. 10, the electronic device 100 may detect the tight-pinch gesture at a single vertex in a line for one hand of the user. Through this, as the hand moves, the electronic device 100 may move the vertex. Here, the electronic device 100 may change the line while maintaining the tangent at the vertex. As shown in (b) of FIG. 10, if the vertex moves to another vertex in another line, the electronic device 100 may connect the line with the other line while merging the vertex with the other vertex. Here, as shown in (c) of FIG. 10, if the tight-pinch gesture is released, the electronic device 100 may maintain the line. Although FIG. 10 illustrates an example of connecting curves, a curve and a straight line may be connected or straight lines may be connected in a similar manner.

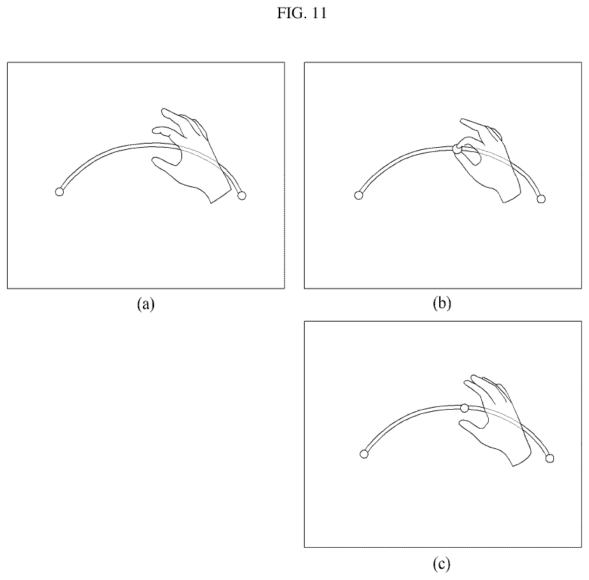

Referring to FIG. 11, the electronic device 100 may divide a single line into two lines in space. In detail, as shown in (a) of FIG. 11, the electronic device 100 may detect the tight-pinch gesture within a line for one hand of the user. In this case, as shown in (b) of FIG. 11, the electronic device 100 may generate a vertex at a position of the hand in the line. Through this, the line may be divided into two lines based on the vertex. Here, as shown in (c) of FIG. 11, if the tight-pinch gesture is released, the electronic device 100 may maintain the lines. Although FIG. 11 illustrates an example of dividing a single curve into two curves, a straight line may be divided into two straight lines in a similar manner.

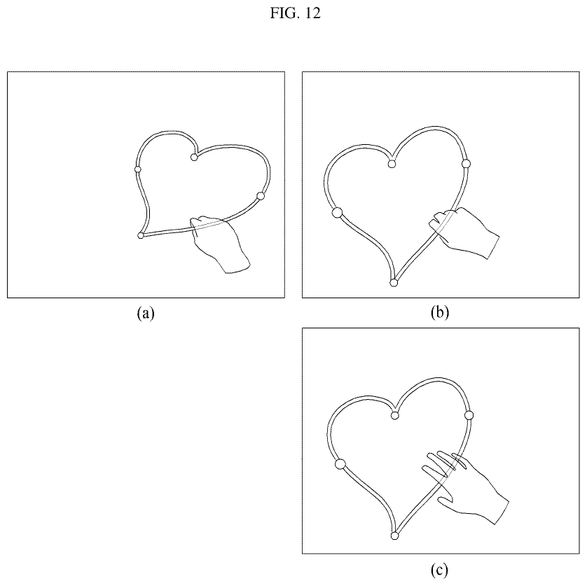

Referring to FIG. 12, the electronic device 100 may rearrange a line in space. In detail, as shown in (a) of FIG. 12, the electronic device 100 may detect the tight-grab gesture within the line for one hand of the user. In this case, as shown in (b) of FIG. 12, the electronic device 100 may move the line as the hand moves, or may rotate the line as the hand rotates. Here, the line may be moved or rotated without modification. When the line forms a closed figure with at least one another line, the electronic device 100 may move or rotate the entire figure without modification as the hand moves. Here, as shown in (c) of FIG. 12, if the tight-grab gesture is released, the electronic device 100 may maintain the line.

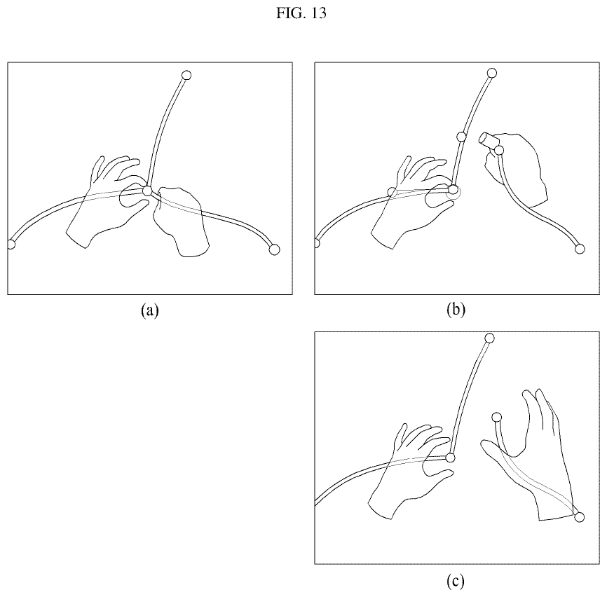

Referring to FIG. 13, the electronic device 100 may separate a line from a vertex in space. In detail, as shown in (a) of FIG. 13, the electronic device 100 may detect the loose-pinch gesture at a single vertex for one hand (e.g., non-dominant hand (NDH)) of the user and may detect the tight-grab gesture in a line connected to the vertex for the other hand (e.g., dominant hand (DH)) of the user. In this case, as shown in (b) of FIG. 13, as the other hand moves, the electronic device 100 may separate the line from the vertex. Here, as the other hand moves, the line may also move and the electronic device 100 may generate a new vertex at the exposed end of the line. Here, as shown in (c) of FIG. 13, if the loose-pinch gesture and the tight-grab gesture are released, the electronic device 100 may maintain the line.

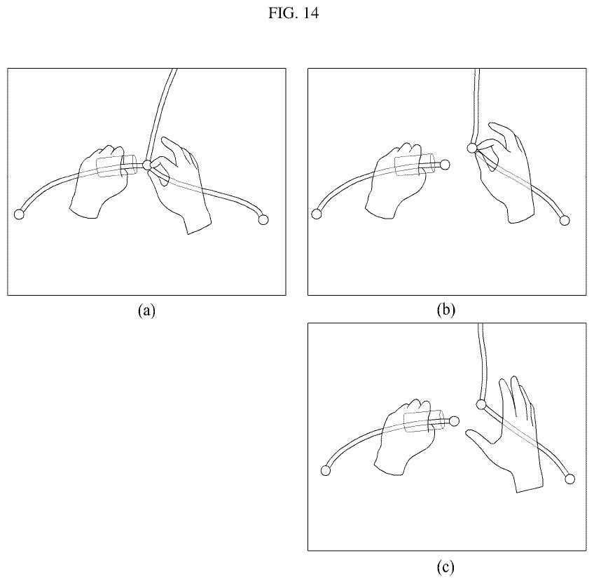

Referring to FIG. 14, the electronic device 100 may separate a vertex from a line in space. In detail, as shown in (a) of FIG. 14, the electronic device 100 may detect the loose-grab gesture in a single line for one hand (e.g., non-dominant hand (NDH)) of the user and may detect the tight-pinch gesture at a vertex connected to the line for the other hand (e.g., dominant hand (DH)) of the user. In this case, as shown in (b) of FIG. 14, as the other hand moves, the electronic device 100 may separate the vertex from the line. Here, as the other hand moves, the vertex may also move and the electronic device 100 may generate a new vertex at the exposed end of the line. If at least one the other line is connected to the vertex, the other line may also move along with the vertex. Here, as shown in (c) of FIG. 14, if the loose-grab gesture and the tight-pinch gesture are released, the electronic device 100 may maintain the vertex.

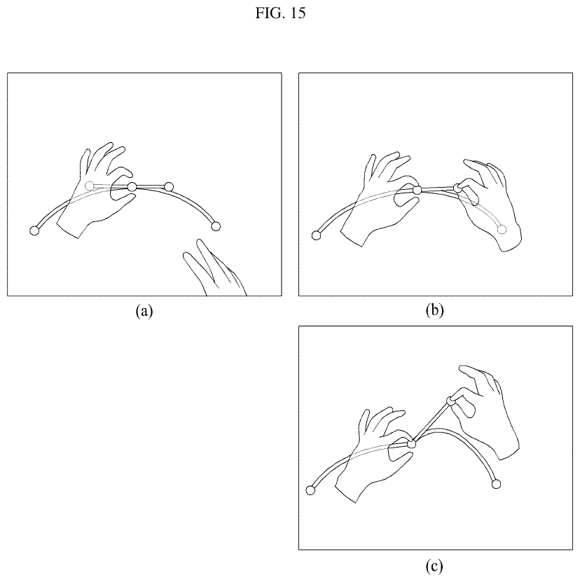

Referring to FIG. 15, the electronic device 100 may edit a line connected to a vertex based on the vertex in space. In detail, as shown in (a) of FIG. 15, the electronic device 100 may detect the loose-pinch gesture at a vertex for one hand (e.g., non-dominant hand (NDH)) of the user. In this case, the electronic device 100 may display a cursor indicating a position of the vertex and at least one control point adjacent to the cursor. Then, as shown in (b) of FIG. 15, the electronic device 100 may detect the tight-pinch gesture at the control point for the other hand (e.g., dominant hand (DH)) of the user. In this case, as shown in (c) of FIG. 15, as the other hand moves, the electronic device 100 may edit a line connected to the vertex. Here, the electronic device 100 may change the tangent at the vertex to correspond to a virtual line that connects the vertex and the control point while maintaining a position of the vertex. Here, although not illustrated, if the loose-pinch gesture and the tight-pinch gesture are released, the electronic device 100 may maintain the vertex and the line.

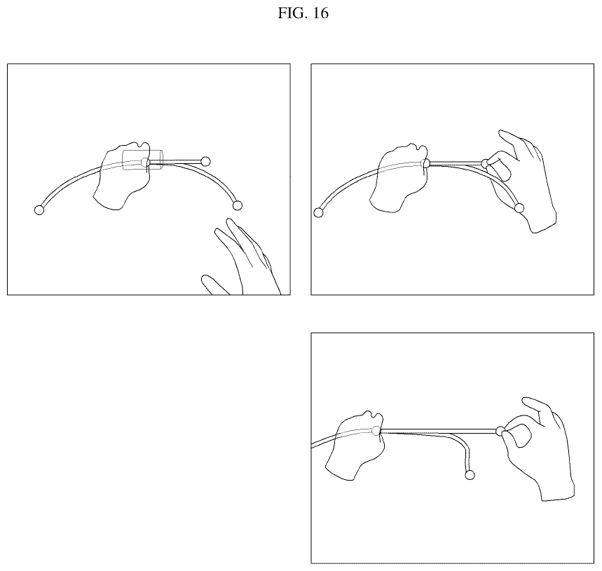

Referring to FIG. 16, the electronic device 100 may edit a line connected to a vertex based on the vertex in space. In detail, as shown in (a) of FIG. 16, the electronic device 100 may detect the loose-grab gesture at the vertex for one hand (e.g., non-dominant hand (NDH)) of the user. In this case, the electronic device 100 may display a cursor indicating a position and the tangent of the vertex and at least one control point adjacent to the cursor. Then, as shown in (b) of FIG. 16, the electronic device 100 may detect the tight-pinch gesture at the control point for the other hand (e.g., dominant hand (DH)) of the user. In this case, as shown in (c) of FIG. 16, as the other hand moves, the electronic device 100 may edit a line connected to the vertex. Here, the electronic device 100 may maintain the tangent at the vertex. Here, although not illustrated, if the loose-grab gesture and the tight-pinch gesture are released, the electronic device 100 may maintain the vertex and the line.

As described above, the electronic device 100 may produce a virtual reality 3D curve network using bimanual interaction of the user. In detail, while the user is wearing the electronic device 100, the electronic device 100 may produce a virtual 3D curve network according to a gesture of at least one hand of the user in the space. The gesture may include the loose-pinch gesture, the tight-pinch gesture, the loose-grab gesture, and the tight-grab gesture based on the pinch gesture and the grab gesture. That is, the electronic device 100 may produce the 3D curve network in the space by generating and modifying lines according to the gesture of at least one hand of the user.

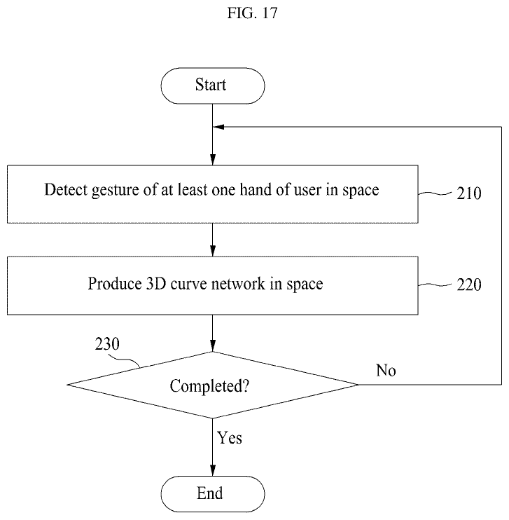

FIG. 17 is a flowchart illustrating an operating method of the electronic device 100 according to various example embodiments.

Referring to FIG. 17, in operation 210, the electronic device 100 may detect a gesture of at least one hand of a user in space. In detail, while the user is wearing the electronic device 100, the processor 170 may detect the gesture of at least one hand of the user in the space. Here, when the electronic device 100 is implemented as a near-eye display device, the processor 170 may monitor the at least one hand of the user within a video while capturing the video of the user's front view through the camera module 110. Here, when the at least one hand of the user performs a predetermined gesture, the processor 170 may detect the gesture. As described above with reference to FIGS. 3 and 4, the gesture may be based on a pinch gesture and a grab gesture, and may include a loose-pinch gesture, a tight-pinch gesture, a loose-grab gesture, and a tight-grab gesture.

Then, in operation 220, the electronic device 100 may produce a virtual 3D curve network according to the gesture of the at least one hand of the user in the space. In detail, as described above with reference to FIGS. 5, 6, 7, 8, 9, 10, 11, 12, 13, 14, 15, and 16, the processor 170 may generate a new line or may modify the generated line according to the gesture of the at least one hand of the user. Here, each line may be defined to connect two vertices, and each line may be a straight line or a curve. In operation 230, if an operation of the electronic device 100 for producing the 3D curve network is not completed, the electronic device 100 may continuously produce the 3D curve network by repeatedly performing operations 210 and 220. Through this, the 3D curve network may include a plurality of lines.

According to the present disclosure, a user may intuitively produce a 3D curve network using bimanual interaction in virtual reality through the electronic device 100. In detail, the electronic device 100 allows the user to easily generate and modify lines at real-world scales in virtual reality through a gesture of both hands while directly viewing the lines. Therefore, in virtual reality, the 3D curve network may be generated with high expressiveness and precision.

In short, the present disclosure provides a method and device for producing a virtual reality 3D curve network using bimanual interaction.

According to the present disclosure, a method of producing a virtual reality 3D curve network using bimanual interaction of the electronic device 100 may include detecting a gesture of at least one hand of a user in space (operation 210), and producing a 3D curve network that includes a plurality of lines according to the gesture in the space and in which each of the lines is defined between two vertices (operation 220).

In various example embodiments, the gesture may be based on a pinch gesture by two fingers and a grab gesture by five fingers.

In various example embodiments, the gesture may include a loose-pinch gesture in which the two fingers are spaced apart from each other, a tight-pinch gesture in which the two fingers are in close contact with each other, a loose-grab gesture in which at least some of the five fingers are spaced apart from each other, and a tight-grab gesture in which the five fingers are in close contact with each other.

In various example embodiments, the producing of the 3D curve network (operation 220) may include, if the tight-pinch gesture is detected for each of both hands of the user, generating vertices at positions of the both hands and generating a straight line that connects the vertices (see FIG. 5).

In various example embodiments, the producing of the 3D curve network (operation 220) may include, if a distance between the both hands increases, extending the straight line while moving the vertices to the positions of the both hands (see FIG. 5).

In various example embodiments, the producing of the 3D curve network (operation 220) may include, if the tight-grab gesture is detected at each of vertices in a straight line for the both hands of the user, generating a curve by bending the straight line as directions of the both hands change (see FIG. 6).

In various example embodiments, the producing of the 3D curve network (operation 220) may include, if the tight-grab gesture is detected at each of vertices in a line for the both hands of the user, removing the line as a distance between the both hands decreases to be less than or equal to a predetermined distance (see FIG. 7).

In various example embodiments, the producing of the 3D curve network (operation 220) may include, if the tight-pinch gesture is detected at a single vertex in a line for one hand of the user, moving the vertex as the one hand moves and changing the line while maintaining the tangent at the vertex (see FIG. 8).

In various example embodiments, the producing of the 3D curve network (operation 220) may include, if the tight-grab gesture is detected at a single vertex in a line for one hand of the user, moving the vertex as the one hand moves and changing the line along with the tangent at the vertex (see FIG. 9).

In various example embodiments, the producing of the 3D curve network (operation 220) may include, if the vertex moves to another vertex in another line, connecting the line to the other line while merging the vertex with the other vertex (see FIG. 10).

In various example embodiments, the producing of the 3D curve network (operation 220) may include, if the tight-pinch gesture is detected within a line for one hand of the user, generating a vertex at a position of the one hand in the line and dividing the line into two straight lines or two curves (see FIG. 11).

In various example embodiments, the producing of the 3D curve network (operation 220) may include, if the tight-grab gesture is detected within a line for one hand of the user, moving the line as the one hand moves (see FIG. 12).

In various example embodiments, the producing of the 3D curve network (operation 220) may include, if the tight-grab gesture is detected within a line for one hand of the user, rotating the line as the one hand rotates (see FIG. 12).

In various example embodiments, the producing of the 3D curve network (operation 220) may include, if the loose-pinch gesture is detected at a single vertex for one hand of the user and the tight-grab gesture is detected in a line connected to the vertex for the other hand of the user, separating the connected line from the vertex while moving the connected line as the other hand moves (see FIG. 13).

In various example embodiments, the producing of the 3D curve network (operation 220) may include, if the loose-grab gesture is detected in a single line for one hand of the user and the tight-pinch gesture is detected at a vertex connected to the line for the other hand of the user, separating the connected vertex from the line while moving the connected vertex as the other hand moves (see FIG. 14).

In various example embodiments, the producing of the 3D curve network (operation 220) may include, if the loose-pinch gesture is detected at a vertex for one hand of the user, displaying a cursor indicating a position of the vertex and at least one control point adjacent to the cursor; and if the tight-pinch gesture is detected at the control point for the other hand of the user, changing a line connected to the vertex while changing the tangent at the vertex to correspond to a virtual line that connects the vertex and the control point as the other hand moves (see FIG. 15).

In various example embodiments, the producing of the 3D curve network (operation 220) may include, if the loose-grab gesture is detected at a vertex for one hand of the user, displaying a cursor indicating a position and the tangent of the vertex and at least one control point adjacent to the cursor; and if the tight-pinch gesture is detected at the control point for the other hand of the user, changing a line connected to the vertex while maintaining the tangent at the vertex as the other hand moves (see FIG. 16).

According to the present disclosure, the electronic device 100 for producing a virtual reality 3D curve network using bimanual interaction may include the camera module 110, the display module 140, and the processor 170 configured to detect a gesture of at least one hand of a user in space through the camera module 110, and to produce a 3D curve network that includes a plurality of lines according to the gesture in the space and in which each of the lines is defined between two vertices through the display module 140.

The systems described herein may be implemented using hardware components, software components, and/or combination of the hardware components and the software components. For example, the systems and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to various example embodiments may be implemented in a form of a program instruction executable through various computer methods and recorded in computer-readable media. Here, the media may be to continuously store a computer-executable program or to temporarily store the same for execution or download. The media may be various types of recording methods or storage methods in which single hardware or a plurality of hardware is combined and may be distributed over a network without being limited to a medium that is directly connected to a computer system. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance and the terms are simply used to distinguish one component from another component. The components should not be limited by the terms. When a component (e.g., first component) is described to be “(functionally or communicatively) connected to” or “accessed to” another component (e.g., second component), the component may be directly connected to the other component or may be connected through still another component (e.g., third component).

The term “module” used herein includes a unit configured as hardware, software, or firmware, and may be interchangeably used with the term, for example, logic, logic block, part, or circuit. The module may be an integrally configured part, a minimum unit that performs one or more functions, or a portion thereof. For example, the module may be configured as an application-specific integrated circuit (ASIC).

According to various example embodiments, each of the components (e.g., module or program) may include a singular object or a plurality of objects. According to various example embodiments, at least one of the components or operations may be omitted. Alternatively, at least one another component or operation may be added. Alternatively or additionally, a plurality of components (e.g., module or program) may be integrated into a single component. In this case, the integrated component may perform one or more functions of each of the components in the same or similar manner as it is performed by a corresponding component before integration. According to various example embodiments, operations performed by a module, a program, or another component may be performed in a sequential, parallel, iterative, or heuristic manner. Alternatively, at least one of the operations may be performed in different sequence or omitted. Alternatively, at least one another operation may be added.

What is claimed is:

1. A method of producing a virtual reality three-dimensional (3D) curve network using bimanual interaction of an electronic device, the method comprising:
detecting a gesture of at least one hand of a user in space; and
producing a 3D curve network that includes a plurality of lines according to the gesture in the space and in which each of the lines is defined between two vertices,
wherein the gesture is based on a pinch gesture by two fingers and a grab gesture by five fingers.

2. The method of claim 1, wherein the gesture includes a loose-pinch gesture in which the two fingers are spaced apart from each other, a tight-pinch gesture in which the two fingers are in close contact with each other, a loose-grab gesture in which at least some of the five fingers are spaced apart from each other, and a tight-grab gesture in which the five fingers are in close contact with each other.

3. The method of claim 2, wherein the producing of the 3D curve network comprises at least one of:
if the tight-pinch gesture is detected for each of both hands of the user, generating vertices at positions of the both hands and generating a straight line that connects the vertices; and
if a distance between the both hands increases, extending the straight line while moving the vertices to the positions of the both hands.

4. The method of claim 2, wherein the producing of the 3D curve network comprises, if the tight-grab gesture is detected at each of vertices in a straight line for the both hands of the user, generating a curve by bending the straight line as directions of the both hands change.

5. The method of claim 2, wherein the producing of the 3D curve network comprises, if the tight-grab gesture is detected at each of vertices in a line for the both hands of the user, removing the line as a distance between the both hands decreases to be less than or equal to a predetermined distance.

6. The method of claim 2, wherein the producing of the 3D curve network comprises at least one of:
if the tight-pinch gesture is detected at a single vertex in a line for one hand of the user, moving the vertex as the one hand moves and changing the line while maintaining the tangent at the vertex; and
if the vertex moves to another vertex in another line, connecting the line to the other line while merging the vertex with the other vertex.

7. The method of claim 2, wherein the producing of the 3D curve network comprises at least one of:
if the tight-grab gesture is detected at a single vertex in a line for one hand of the user, moving the vertex as the one hand moves and changing the line along with the tangent at the vertex;
if the tight-grab gesture is detected within a line for one hand of the user, moving the line as the one hand moves; and
if the tight-grab gesture is detected within a line for one hand of the user, rotating the line as the one hand rotates.

8. The method of claim 2, wherein the producing of the 3D curve network comprises, if the tight-pinch gesture is detected within a line for one hand of the user, generating a vertex at a position of the one hand in the line and dividing the line into two straight lines or two curves.

9. The method of claim 2, wherein the producing of the 3D curve network comprises at least one of:
if the loose-pinch gesture is detected at a single vertex for one hand of the user and the tight-grab gesture is detected in a line connected to the vertex for the other hand of the user, separating the connected line from the vertex while moving the connected line as the other hand moves; and
if the loose-grab gesture is detected in a single line for one hand of the user and the tight-pinch gesture is detected at a vertex connected to the line for the other hand of the user, separating the connected vertex from the line while moving the connected vertex as the other hand moves.

10. The method of claim 2, wherein the producing of the 3D curve network comprises:
if the loose-pinch gesture is detected at a vertex for one hand of the user, displaying a cursor indicating a position of the vertex and at least one control point adjacent to the cursor; and
if the tight-pinch gesture is detected at the control point for the other hand of the user, changing a line connected to the vertex while changing the tangent at the vertex to correspond to a virtual line that connects the vertex and the control point as the other hand moves.

11. The method of claim 2, wherein the producing of the 3D curve network comprises:
if the loose-grab gesture is detected at a vertex for one hand of the user, displaying a cursor indicating a position and the tangent of the vertex and at least one control point adjacent to the cursor; and
if the tight-pinch gesture is detected at the control point for the other hand of the user, changing a line connected to the vertex while maintaining the tangent at the vertex as the other hand moves.

12. An electronic device for producing a virtual reality three-dimensional (3D) curve network using bimanual interaction, the electronic device comprising:
a camera module;
a display module; and
a processor configured to detect a gesture of at least one hand of a user in space through the camera module, and to produce a 3D curve network that includes a plurality of lines according to the gesture in the space and in which each of the lines is defined between two vertices through the display module,
wherein the gesture is based on a pinch gesture by two fingers and a grab gesture by five fingers.

13. A computer program stored in a non-transitory computer-readable recording medium to execute a method of producing a virtual reality three-dimensional (3D) curve network using bimanual interaction in an electronic device, wherein the method comprises:
detecting a gesture of at least one hand of a user in space; and
producing a 3D curve network that includes a plurality of lines according to the gesture in the space and in which each of the lines is defined between two vertices, and
the gesture is based on a pinch gesture by two fingers and a grab gesture by five fingers.
